(19) United States
(12) Patent Application Publication
(10) Pub. No.: US 2017/0041142 A1
(43) Pub. Date: Feb. 9, 2017

(54) SIGNAL PROCESSING METHOD AND APPARATUS, CONTROLLING APPARATUS, AND CONTROLLED APPARATUS

(71) Applicant: CAPITAL EAGLE HOLDINGS LIMITED, SINGAPORE (SG)

(72) Inventors: KUN-LIANG HSIEH, NEW TAIPEI CITY (TW); KUO-LIANG WEI, NEW TAIPEI CITY (TW); CHING-YAU KANG, SINGAPORE (SG); WENG-WAH CHNG, SINGAPORE (SG)

(21) Appl. No.: 15/086,031

(22) Filed: Mar. 30, 2016

(30) Foreign Application Priority Data
Aug. 5, 2015 (CN) 201510475668.6

(51) Int. Cl. H04L 9/32

(52) U.S. Cl. CPC H04L 9/3226; H04L 9/3236

(57) ABSTRACT

A signal processing method includes: fetching an encrypted identifier of a controlled apparatus; filling the encrypted identifier into a device identification field of a data format of a control signal; generating an encrypted time code according to system time and an adjusting code of a controlling apparatus; filling the encrypted time code into a time identification field of the data format; generating a control signal having both device identification field and time identification field; receiving the control signal and fetching both device identification field and time identification field; comparing the device identification field with a predetermined device identification field; comparing the time identification field with the predetermined time identification field if the device identification field is equal to the predetermined device identification field; and executing an operation corresponsive to the control signal by the controlled apparatus if the time identification field is greater than the predetermined time identification field.

### CROSS-REFERENCE TO RELATED APPLICATIONS

This non-provisional application claims priority under 35 U.S.C. §119(a) on Patent Application No(s). 201510475668.6 filed in China on Aug. 5, 2015, the entire contents of which are hereby incorporated by reference.

### TECHNICAL FIELD

The technical field relates to signal processing technology, and more particularly to a signal processing method and apparatus, a controlling apparatus, and a controlled apparatus.

### BACKGROUND

To improve the convenience of controlling a device, a wireless remote controller is generally used. At present, infrared remote controller a common remote controller used extensively in our daily life. As long as the infrared remote controller matches the device, the device can be controlled to perform corresponsive operations.

However, the infrared remote controller is usually for controlling one device only, and thus the expandability is low and limits the application of the remote controller. Since infrared does not have the confidential function and any remote controller matched with the device may be used for controlling the operation of the device, therefore the security of the signal transmission is insufficient.

### SUMMARY

In view of the problems of the prior art, it is a primary objective of this disclosure to provide a signal processing method and apparatus, a controlling apparatus, and a controlled apparatus capable of enhancing the expandability of a system and the confidentiality of a signal transmission.

To achieve the aforementioned and other objectives, this disclosure provides a signal processing method, comprising the steps of: etching an encrypted identifier of a controlled apparatus; filling the encrypted identifier into a device identification field of a data format of a control signal; generating an encrypted time code according to a system time and adjusting code of the controlling apparatus; filling the encrypted time code into a time identification field of the data format; generating the control signal having the device identification field and the time identification field; receiving a control signal of a controlling apparatus; fetching the device identification field and the time identification field of the data format from the control signal; comparing the device identification field with a predetermined device identification field; comparing the time identification field with a predetermined time identification field, if the device identification field is equal to the predetermined device identification field; and executing an operation corresponsive to the control signal by the controlled apparatus, if the time identification field is greater than the predetermined time identification field.

Wherein, the data format further comprises a header identification field, a serial number identification field, action identification field, a checksum identification field, and a tail identification field.

Wherein, the number of bits of the data format is not greater than 20 bytes, and both of the encrypted identifier and the encrypted time code are calculated by Hash function. In a preferred embodiment of this disclosure, a signal processing method of a controlling apparatus is further disclosed. The signal processing method of a controlling apparatus comprises the steps of: fetching an encrypted identifier of a controlled apparatus; filling the encrypted identifier into a device identification field of a data format of a control signal; generating an encrypted time code according to system time and an adjusting code of the controlling apparatus; filling the encrypted time code into a time identification field of the data format; and generating the control signal having the device identification field and the time identification field.

Wherein, the data format further comprises a header identification field, a serial number identification field, an action identification field, a checksum identification field, and a tail identification field.

Wherein, the number of bits of the data format is not greater than 20 bytes, and both of the encrypted identifier and the encrypted time code are calculated by Hash function. In a preferred embodiment of this disclosure, a signal processing method of a controlled apparatus is disclosed. The signal processing method of a controlled apparatus comprises the steps of: receiving a control signal of a controlling apparatus; fetching a device identification field and a time identification field of a data format from the control signal; comparing the device identification field with a predetermined device identification field; comparing the time identification field with the predetermined time identification field, if the device identification field is equal to the predetermined device identification field; and executing an operation corresponsive to the control signal by the controlled apparatus, if the time identification field is greater than predetermined time identification field.

Wherein, the data format further comprises a header identification field, a serial number identification field, an action identification field, a checksum identification field, and a tail identification field.

Wherein, the number of bits of the data format is not greater than 20 bytes, and both of the encrypted identifier and the encrypted time code are calculated by Hash function.

In a preferred embodiment of this disclosure, a signal processing system is further disclosed. The signal processing system comprises: a controlling apparatus, further comprising: a fetching module, for fetching an encrypted identifier of a controlled apparatus; a first storage module, for storing the system time of the controlling apparatus; a first processing module, for filling the encrypted identifier into a device identification field of a data format of a control signal, and generating an encrypted time code according to system time and an adjusting code, and filling the encrypted time code into a time identification field of the data format to generate the control signal having the device identification field and the time identification field; a controlled apparatus, further comprising: a receiving module, for receiving a control signal of a controlling apparatus; a second storage module, for storing a predetermined device identification field and a predetermined time identification field; a second processing module, for fetching a device identification field and a time identification field of the data format form from the control signal, and comparing the device identification field with the predetermined device identification field, and comparing the time identification field with the predetermined time identification field if the device identification field is equal to the predetermined device identification field, and executing an operation corresponsive to the control signal if the time identification field is greater than the predetermined time identification field.

Wherein, the data format comprises a header identification field, a serial number identification field, an action identification field, a checksum identification field, and a tail identification field.

Wherein, the number of bits of the data format is not greater than 20 bytes, and both of the encrypted identifier and the encrypted time code are calculated by Hash function.

In a preferred embodiment of this disclosure, a controlling apparatus is further disclosed. The controlling apparatus comprises: a fetching module, for fetching an encrypted identifier of a controlled apparatus; a storage module, for storing a system time of the controlling apparatus; a processing module, for filling the encrypted identifier into a device identification field of a data format of a control signal, and generating an encrypted time code according to a system time and an adjusting code, and filling the encrypted time code into a time identification field of the data format to generate the control signal having the device identification field and the time identification field.

Wherein, the data format comprises a header identification field, a serial number identification field, an action identification field, a checksum identification field, and a tail identification field.

Wherein, the number of bits of the data format is not greater than 20 bytes, and both of the encrypted identifier and the encrypted time code are calculated by Hash function.

In a preferred embodiment of this disclosure, a controlled apparatus is further disclosed. The controlled apparatus comprises: a receiving module, for receiving a control signal of a controlling apparatus; a storage module, for storing a predetermined device identification field and a predetermined time identification field; and a processing module, for fetching the device identification field and the time identification field of the data format from the control signal, and comparing the device identification field with the predetermined device identification field, and comparing the time identification field with the predetermined time identification field if the device identification field is equal to the predetermined device identification field, and executing an operation corresponsive to the control signal if the time identification field is greater than the predetermined time identification field.

Wherein, the data format comprises a header identification field, a serial number identification field, an action identification field, a checksum identification field, and a tail identification field.

Wherein, the number of bits of the data format is not greater than 20 bytes, and both of the encrypted identifier and the encrypted time code are calculated by Hash function.

According to the technical solution of this disclosure, the fetched encrypted identifier and the calculated encrypted time code are filled into the device identification field and the time identification field of the data format of the control signal respectively, and then the control signal having the device identification field and the time identification field is generated. In addition, after the control signal of the controlling apparatus is received, the device identification field and the time identification field of the data format are fetched from the control signal, and then the device identification field is compared with the predetermined device identification field and the time identification field is compared with the predetermined time identification field before the controlled apparatus executes an operation corresponsive to the corresponsive operation accordingly, so as to enhance the expandability of the system and the confidentiality of the signal transmission effectively.

### BRIEF DESCRIPTION OF THE DRAWINGS

FIG. 1 is a block diagram of a signal processing system in accordance with a preferred embodiment of this disclosure;

FIG. 2 is a schematic view of the data format of a control signal in accordance with a preferred embodiment of this disclosure;

FIG. 3 is a flow chat of a signal processing method of a controlling apparatus in accordance with a preferred embodiment of this disclosure;

FIG. 4 is a flow chart of a signal processing method of a controlled apparatus in accordance with a preferred embodiment of this disclosure; and

FIG. 5 is a flow chart of a signal processing method in accordance with a preferred embodiment of this disclosure.

### DESCRIPTION OF THE PREFERRED EMBODIMENTS

The main idea of this disclosure is to fill the fetched encrypted identifier and the calculated encrypted time code into the device identification field and the time identification field of the data format of the control signal respectively, and then generating the control signal having the device identification field and the time identification field. After the controlling apparatus is received, the device identification field and the time identification field of the data format are fetched from the control signal and then the device identification field is compared with the predetermined device identification field and the time identification field is compared with the predetermined time identification field before the controlled apparatus executes an operation corresponsive to the control signal accordingly, so as to enhance the expandability of the system and the confidentiality of the signal transmission effectively.

The above and other objects, features and advantages of this disclosure will become apparent from the following detailed description taken with the accompanying drawings.

In a preferred embodiment of this disclosure, a signal processing system is disclosed.

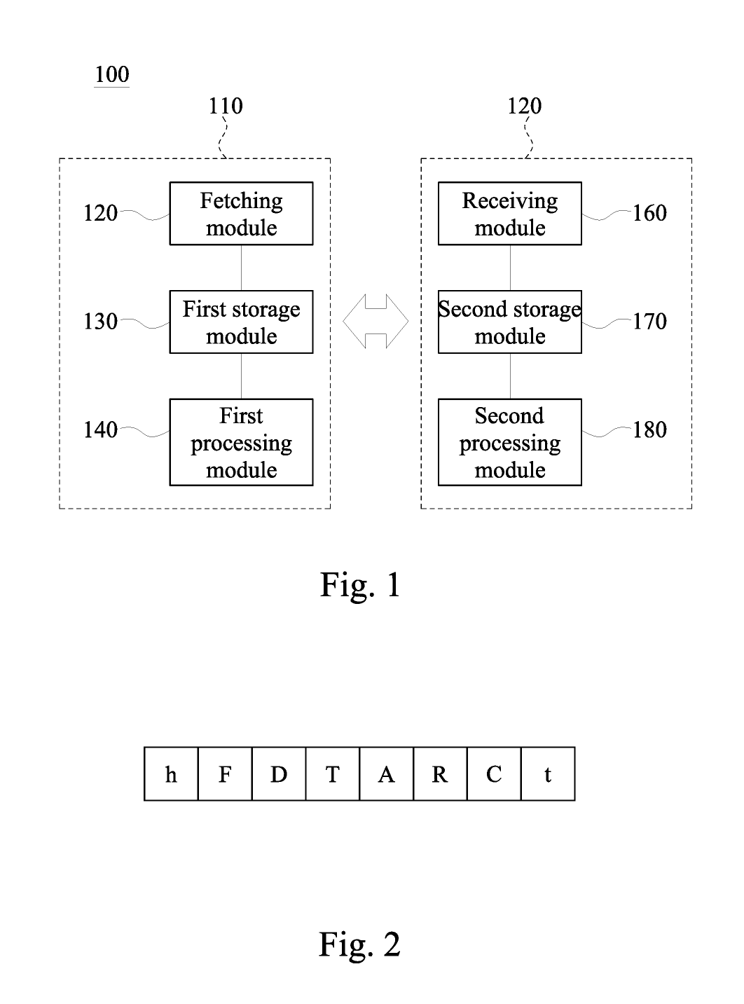

With reference to FIG. 1 for a block diagram of a signal processing system in accordance with a preferred embodiment of this disclosure, the signal processing system 100 comprises a controlling apparatus 110 and a controlled apparatus 150. Wherein, the controlling apparatus 100 is an electric appliance including but not limited to a mobile phone and a remote controller, and the controlled apparatus 150 is an electric appliance including but not limited to an air conditioner and an electric fan. In this preferred embodiment, signals are transmitted between the controlling apparatus 100 and the controlled apparatus 150 through Bluetooth Low Energy (BLE) wireless communication technology.

The controlling apparatus 110 comprises a fetching module 120, a first storage module 130 and a first processing module 140.

The fetching module 120 is provided for fetching an encrypted identifier of a controlled apparatus 150. In a preferred embodiment, the fetching module 120 has the Bluetooth low energy wireless communication function, and the encrypted identifier is calculated by Hash function. In another preferred embodiment, the fetching module 120 is a camera lens, and the encrypted identifier is a two-dimensional barcode such as a quick response (QR) code, so that the fetching module 120 may fetch the encrypted identifier by photography.

The first storage module 130 is provided for storing a system time of the controlling apparatus 110.

The first processing module 140 is provided for filling the encrypted identifier into a device identification field of a data format of a control signal and generating an encrypted time code according to a system time and an adjusting code, and filling the encrypted time code into a time identification field of the data format to generate the control signal having the device identification field and the time identification field. Wherein, the encrypted time code is calculated by Hash function. Since a protection mechanism is added to the control signal generated by the first processing module 140, therefore even if the control signal is stolen during the transmission process, the data format of the control signal is not known. As a result, the transmission of the control signal is more secured.

The controlled apparatus 150 comprises a receiving module 160, a second processing module 170 and a second processing module 180.

The receiving module 160 is provided for receiving a control signal of a controlling apparatus. The receiving module 160 has a Bluetooth low energy wireless communication function.

The second storage module 170 is provided for storing a predetermined device identification field and a predetermined time identification field.

The second processing module 180 is provide for fetching a device identification field and a time identification field of the data format of the control signal and comparing the device identification field with a predetermined device identification field.

The second processing module 180 further compares the time identification field with a predetermined time identification field if the device identification field is equal to the predetermined device identification field, and processes an operation corresponsive to the control signal if the time identification field is greater than the predetermined time identification field. The second processing module 180 substitutes the predetermined time identification field by the current time identification field and stores the current time identification field as the predetermined time identification field in the second module 170, which is used as a basis for comparison when the control signal is received next time. Such arrangement can improve the security of the control signal.

On the other hand, if the device identification field and the predetermined device identification field are not the same, it shows that the control signal cannot be used to control the operation of the controlled apparatus 150, and the second processing module 180 will not perform any processing. If the time identification field and the predetermined time identification field are the same, or the time identification field is smaller than the predetermined time identification field, it shows that the control signal cannot be used to control the operation of the controlled apparatus 150 and the second processing module 180 will not perform any processing.

In this preferred embodiment, the data format further comprises an action identification (Action ID) field A, a reserve identification (Reserve ID) field R, a checksum identification (Checksum ID) field C and a tail identification (Tail ID) field t as shown in FIG. 2, in addition to the device identification (Device ID) field D and the time identification (Time ID) field T. In addition, the data format is formed by arranging a header identification field h, a serial number identification field F, a device identification field D, a time identification field T, an action identification field A, a reserve identification field R, a checksum identification field C and a tail identification field tin sequence.

In addition, the number of bits of the data format is not greater than 20 bytes in order to increase the transmission speed of the control signal. In a preferred embodiment, the number of bits of the data format are allocated to an identification field h with the number of bits equal to 1 byte, a serial number identification field F with the number of bits equal to 1 byte, a device identification field D with the number of bits equal to 4 bytes, a time identification field T with the number of bits equal to 5 bytes, an action identification field A with the number of bits equal to 7 bytes, a reserve identification field R with the number of bits equal to 0 byte, a checksum identification field C with the number of bits equal to 1 byte and a tail identification field t with the number of bits equal to 1 byte. However, this disclosure is not limited to the aforementioned allocation of bytes, and users may make necessary arrangements as needed. For example, the identification field may have a number of bits equal to 1 byte, and the serial number identification field F may have a number of bits equal to 1 byte, and the device identification field D may have a number of bits equal to 4 bytes, and the time identification field T may have a number of bits equal to 5 bytes, and the action identification field A may have a number of bits equal to 6 bytes, and the reserve identification field R may have a number of bits equal to 1 byte, and the checksum identification field C may have a number of bits equal to 1 byte, and the tail identification field t may have a number of bits equal to 1 byte.

In addition, the encrypted identifier fetched by the fetching module 120 is pre-processed by the controlled apparatus 150 first. In other words, the encrypted identifier is processed and generated by the second processing module 180. For example, the identifier of the controlled apparatus 150 is stored in the second storage module 170. In a preferred embodiment, the second processing module 180 reads the identifier of the controlled apparatus 150 from the second storage module 170 first and calculates the identifier of the controlled apparatus 150 by Hash function to obtain an encrypted identifier. In another preferred embodiment, the second processing module 180 may add an adjusting code. In other words, the identifier of the controlled apparatus and the adjusting code are calculated by the Hash function to obtain the encrypted identifier, so as to improve the security of the encrypted identifier.

To improve the security between the controlling apparatus 110 and the controlled apparatus 150, a comparison to determine whether the serial number identification field F is not equal to the serial number identification field stored in the second storage module 170 is conducted before comparing whether or not the time identification field is greater than predetermined time identification field, and comparing whether or not the time identification field is greater than predetermined time identification field in the foregoing preferred embodiment, so as to improve and control the security of the signal transmission. After the controlling apparatus 110 transmits a control signal each time, the serial number identification field F will be accumulated, so that the serial number identification field of a control signal currently transmitted by the controlling apparatus 110 will not be equal to the serial number identification field of the second storage module 170 of the controlled apparatus 150 in a normal operation.

In other words, if the second processing module 180 determines that that current serial number identification field is not equal to the serial number identification field stored in the second storage module 170, then the second processing module 180 will compare whether or not the time identification field is greater than the predetermined time identification field. If the second processing module 180 determines that the current serial number identification field is equal to the serial number identification field stored in the second storage module 170, it shows that the control signal cannot be used to control the operation of the controlled apparatus 150, and the second processing module 180 will not perform any processing.

Both of the quantity of the controlling apparatus 110 and the quantity of the controlled apparatus 150 are equal to one. In other words, one-to-one signal transmission and control operation are performed. However, this disclosure is not limited to such arrangement only, but the quantity of the controlling apparatus 110 may be two or more, and the quantity of the controlled apparatus 150 may be one. In other words, one-to-many signal transmission and control operation are performed. In addition, the quantity of the controlling apparatus 110 may be one, and the quantity of the controlled apparatus 150 may be two or more, or the quantity of the controlling apparatus 110 may be two or more and the quantity of the controlled apparatus 150 may be one, or both quantities of the controlling apparatus 110 and the controlled apparatus 150 may be two or more to achieve the one-to-many and many-to-many signal transmissions and control operations respectively. The many-to-one, one-to-many, and many-to-many signal transmissions and control operations are described in the foregoing preferred embodiments, and thus will not be repeated.

In a preferred embodiment of this disclosure, a signal processing method of a controlling apparatus is disclosed.

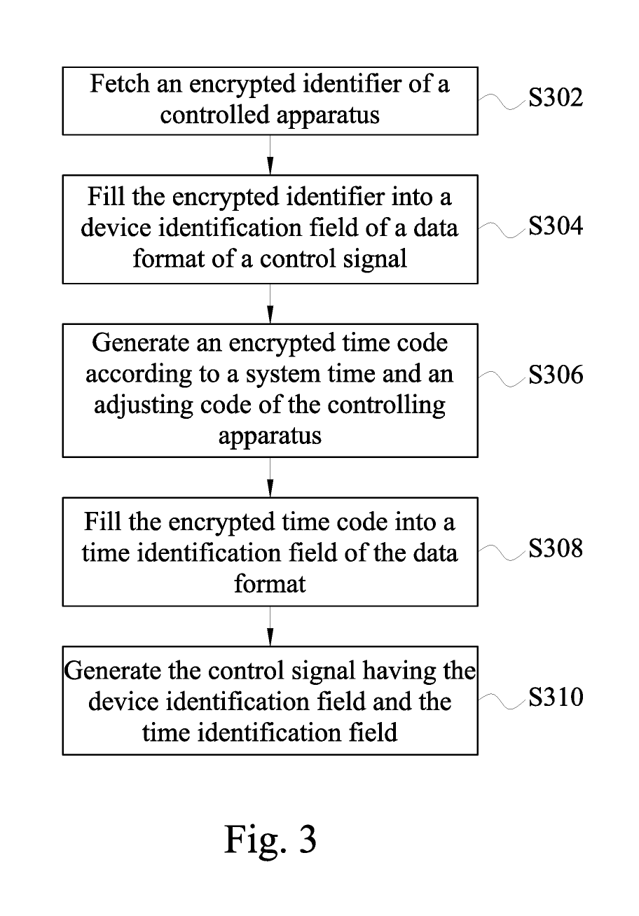

With reference to FIG. 3 for a flow chart of a signal processing method of a controlling apparatus in accordance with a preferred embodiment of this disclosure, the signal processing method comprises the following steps:

S302: Fetch an encrypted identifier of a controlled apparatus.

S304: Fill the encrypted identifier into a device identification field of a data format of a control signal.

S306: Generate an encrypted time code according to a system time and an adjusting code of the controlling apparatus.

S308: Fill the encrypted time code into a time identification field of the data format.

S310: Generate the control signal having the device identification field and the time identification field.

In a preferred embodiment of this disclosure, a signal processing method of a controlled apparatus is disclosed.

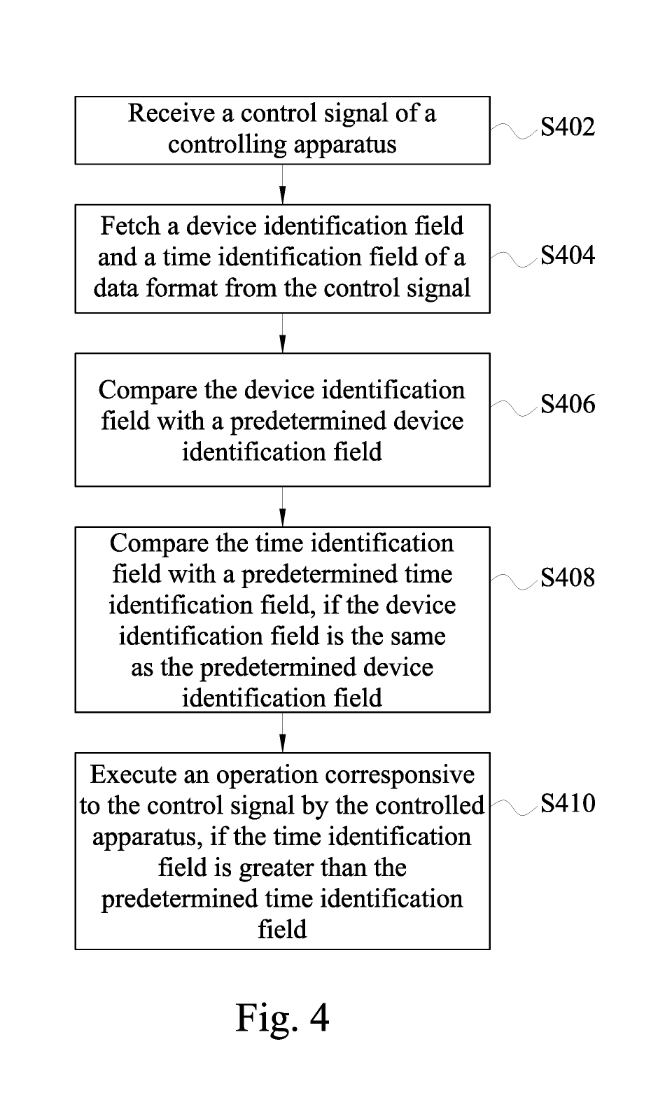

With reference to FIG. 4 for a flow chart of a signal processing method of a controlled apparatus in accordance with a preferred embodiment of this disclosure, the signal processing method comprises the following steps:

S402: Receive a control signal of a controlling apparatus.

S404: Fetch a device identification field and a time identification field of a data format from the control signal.

S406: Compare the device identification field with a predetermined device identification field.

S408: Compare the time identification field with a predetermined time identification field, if the device identification field is the same as the predetermined device identification field.

S410: Execute an operation corresponsive to the control signal by the controlled apparatus, if the time identification field is greater than the predetermined time identification field.

In a preferred embodiment this disclosure, a signal processing method is disclosed.

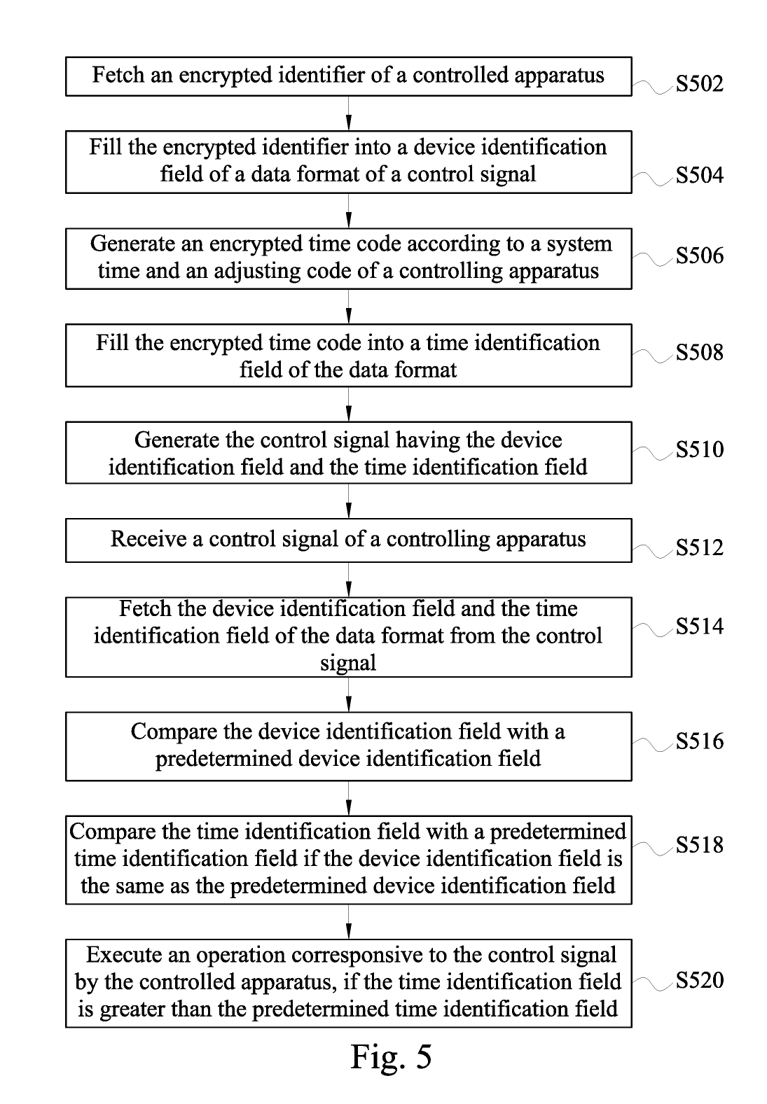

With reference to FIG. 5 for a flow chart of a signal processing method in accordance with a preferred embodiment of this disclosure, the signal processing method comprises the following steps:

S502: Fetch an encrypted identifier of a controlled apparatus.

S504: Fill the encrypted identifier into a device identification field of a data format of a control signal.

S506: Generate an encrypted time code according to a system time and an adjusting code of a controlling apparatus.

S508: Fill the encrypted time code into a time identification field of the data format.

S510: Generate the control signal having the device identification field and the time identification field.

S512: Receive a control signal of a controlling apparatus.

S514: Fetch the device identification field and the time identification field of the data format from the control signal.

S516: Compare the device identification field with a predetermined device identification field.

S518: Compare the time identification field with a predetermined time identification field if the device identification field is the same as the predetermined device identification field.

S520: Execute an operation corresponsive to the control signal by the controlled apparatus, if the time identification field is greater than the predetermined time identification field.

In summation of the description above, the technical solution of this disclosure is to fill the obtained encrypted identifier and the calculated encrypted time code into the device identification field and the time identification field of the data format of the control signal respectively and then generate the control signal having the device identification field and the time identification field. After the control signal of the controlling apparatus is received, the device identification field and the time identification field of the data format are fetched from the control signal, and then the device identification field is compared with the predetermined device identification field and the time identification field is compared with the predetermined time identification field, before the controlled apparatus executes an operation corresponsive to the control signal correspondingly. Such arrangement can improve the expandability of a system and the confidentiality of a signal transmission effectively.

What is claimed is:

1. A signal processing method, comprising the steps of:
fetching an encrypted identifier of a controlled apparatus;
filling the encrypted identifier into a device identification field of a data format of a control signal;
generating an encrypted time code according to a system time and an adjusting code of the controlling apparatus;
filling the encrypted time code into a time identification field of the data format;
generating the control signal having the device identification field and the time identification field;
receiving a control signal of a controlling apparatus;
fetching the device identification field and the time identification field of the data format from the control signal;
comparing the device identification field with a predetermined device identification field;
comparing the time identification field with a predetermined time identification field, if the device identification field is equal to the predetermined device identification field; and
executing an operation corresponsive to the control signal by the controlled apparatus, if the time identification field is greater than the predetermined time identification field.

2. The signal processing method according to claim 1, wherein the data format further comprises a header identification field, a serial number identification field, an action identification field, a checksum identification field, and a tail identification field.

3. The signal processing method according to claim 1, wherein the number of bits of the data format is not greater than 20 bytes.

4. The signal processing method according to claim 1, wherein the encrypted identifier is calculated by Hash function.

5. The signal processing method according to claim 1, wherein the encrypted time code is calculated by Hash function.

6. A signal processing method of a controlling apparatus, comprising the steps of:
fetching an encrypted identifier of a controlled apparatus;
filling the encrypted identifier into a device identification field of a data format of a control signal;
generating an encrypted time code according to a system time and an adjusting code of the controlling apparatus;
filling the encrypted time code into a time identification field of the data format; and
generating the control signal having the device identification field and the time identification field.

7. The signal processing method of a controlling apparatus according to claim 6, wherein the data format further comprises a header identification field, a serial number identification field, an action identification field, a checksum identification field, and a tail identification field.

8. The signal processing method of a controlling apparatus according to claim 6, wherein the number of bits of the data format is not greater than 20 bytes.

9. The signal processing method of a controlling apparatus according to claim 6, wherein the encrypted identifier is calculated by Hash function.

10. The signal processing method of a controlling apparatus according to claim 6, wherein the encrypted time code is calculated by Hash function.

11. A signal processing method of a controlled apparatus, comprising the steps of:
receiving a control signal of a controlling apparatus;
fetching a device identification field and a time identification field of a data format from the control signal;
comparing the device identification field with a predetermined device identification field;
comparing the time identification field with a predetermined time identification field, if the device identification field is equal to the predetermined device identification field; and
executing an operation corresponsive to the control signal by the controlled apparatus, if the time identification field is greater than the predetermined time identification field.

12. The signal processing method of a controlled apparatus according to claim 11, wherein the data format further comprises a header identification field, a serial number identification field, an action identification field, a checksum identification field, and a tail identification field.

13. The signal processing method of a controlled apparatus according to claim 11, wherein the number of bits of the data format is not greater than 20 bytes.

14. The signal processing method of a controlled apparatus according to claim 11, wherein the encrypted identifier is calculated by Hash function.

15. The signal processing method of a controlled apparatus according to claim 11, wherein the encrypted time code is calculated by Hash function.

16. A signal processing system, comprising:
a controlling apparatus, further comprising:
a fetching module, for fetching an encrypted identifier of a controlled apparatus; a first storage module, for storing a system time of the controlling apparatus;
a first processing module, for filling the encrypted identifier into a device identification field of a data format of a control signal, and generating an encrypted time code according to the system time and an adjusting code, and filling the encrypted time code into a time identification field of the data format to generate the control signal having the device identification field and the time identification field;
a controlled apparatus, further comprising:
a receiving module, for receiving a control signal of a controlling apparatus;
a second storage module, for storing a predetermined device identification field and a predetermined time identification field;
a second processing module, for fetching a device identification field and a time identification field of the data format form from the control signal, and comparing the device identification field with the predetermined device identification field, and comparing the time identification field with the predetermined time identification field if the device identification field is equal to the predetermined device identification field, and executing an operation corresponsive to the control signal if the time identification field is greater than the predetermined time identification field.

17. The signal processing system according to claim 16, wherein the data format comprises a header identification field, a serial number identification field, an action identification field, a checksum identification field, and a tail identification field.

18. The signal processing system according to claim 16, wherein the number of bits of the data format is not greater than 20 bytes.

19. The signal processing system according to claim 16, wherein the encrypted identifier is calculated by Hash function.

20. The signal processing system according to claim 16, wherein the encrypted time code is calculated by Hash function.

21. A controlling apparatus, comprising:
a fetching module, for fetching an encrypted identifier of a controlled apparatus;
a storage module, for storing a system time of the controlling apparatus;
a processing module, for filling the encrypted identifier into a device identification field of a data format of a control signal, and generating an encrypted time code according to a system time and an adjusting code, and filling the encrypted time code into a time identification field of the data format to generate the control signal having the device identification field and the time identification field.

22. The controlling apparatus according to claim 21, wherein the data format further comprises a header identification field, a serial number identification field, an action identification field, a checksum identification field, and a tail identification field.

23. The controlling apparatus according to claim 21, wherein the number of bits of the data format is not greater than 20 bytes.

24. The controlling apparatus according to claim 21, wherein the encrypted identifier is calculated by Hash function.

25. The controlling apparatus according to claim 21, wherein the encrypted time code is calculated by Hash function.

26. A controlled apparatus, comprising:
a receiving module, for receiving a control signal of a controlling apparatus;
a storage module, for storing a predetermined device identification field and a predetermined time identification field; and
a processing module, for fetching the device identification field and the time identification field of the data format from the control signal, and comparing the device identification field with the predetermined device identification field, and comparing the time identification field with the predetermined time identification field if the device identification field is equal to the predetermined device identification field, and executing an operation corresponsive to the control signal if the time identification field is greater than the predetermined time identification field.

27. The controlled apparatus according to claim 26, wherein the data format further comprises a header identification field, a serial number identification field, an action identification field, a checksum identification field, and a tail identification field.

28. The controlled apparatus according to claim 26, wherein the number of bits of the data format is not greater than 20 bytes.

29. The controlled apparatus according to claim 26, wherein the encrypted identifier is calculated by Hash function.

30. The controlled apparatus according to claim 26, wherein the encrypted time code is calculated by Hash function.
